(19) United States
(12) Patent Application Publication
(10) Pub. No.: US 2016/0019489 A1
(43) Pub. Date: Jan. 21, 2016

(54) PRIORITIZING BUSINESS CAPABILITY GAPS

(71) Applicant: International Business Machines Corporation, Armonk, NY (US)

(72) Inventors: Robert W. BERGMANN, Elk Grove Village, IL (US); Louise M. HEMOND-WILSON, Owosso, MI (US); Ronnie L. HUSKEY, Haslet, TX (US); Celestine B. METUASSALOL, Katy, TX (US); David E. WRIGHT, Plainfield, IL (US)

(21) Appl. No.: 14/452,131

(22) Filed: Aug. 5, 2014

Related U.S. Application Data
(63) Continuation of application No. 14/336,038, filed on Jul. 21, 2014.

(51) Int. Cl. G06Q 10/06

(52) U.S. Cl. CPC G06Q 10/06393; G06Q 10/067

(57) ABSTRACT

Method to perform an operation to prioritize capability gaps, the operation comprising determining, for each of a plurality of business objectives, a weighted effectiveness, criticality, and differentiation (ECD) score, and determining operation of one or more processors, a priority value for each of a plurality of capability gaps based on: (i) the weighted ECD score of each business objective, and (ii) a degree of support the respective capability gap provides towards fulfilling each business objective, wherein each priority value reflects a degree of importance of a capability subject to the respective capability gap.

### CROSS-REFERENCE TO RELATED APPLICATION

This application is a continuation of co-pending U.S. patent application Ser. No. 14/336,038, filed Jul. 21, 2014. The aforementioned related patent application is herein incorporated by reference in its entirety.

### BACKGROUND

The present disclosure relates to techniques to prioritize business capability gaps.

Organizations struggle to prioritize gaps in business capabilities. Often, business initiatives themselves lack prioritization, further complicating the problem. Due to extensive project backlogs, many organizations reject additional projects they should undertake if they otherwise had the resources to complete the projects.

### SUMMARY

Embodiments disclosed herein provide at least a system, method, and computer program product to perform an operation to prioritize capability gaps, the operation comprising determining, for each of a plurality of business objectives, a weighted effectiveness, criticality, and differentiation (ECD) score, and determining a priority value for each of a plurality of capability gaps based on: (i) the weighted ECD score of each business objective, and (ii) a degree of support the respective capability gap provides towards fulfilling each business objective, wherein each priority value reflects a degree of importance of a capability subject to the respective capability gap.

### BRIEF DESCRIPTION OF THE SEVERAL VIEWS OF THE DRAWINGS

FIG. 1 illustrates a graphical user interface depicting identified and prioritized business capability gaps, according to one embodiment.

FIG. 2 illustrates a system to prioritize business capability gaps, according to one embodiment.

FIG. 3 illustrates a table storing current and desired levels of compliance with business capabilities to identify business capability gaps, according to one embodiment.

FIG. 4 illustrates a table including computed weighted effectiveness, criticality, and competitive differentiation scores for business strategies, according to one embodiment.

FIG. 5 is a table including computed priority values for identified business capability gaps, according to one embodiment.

FIG. 6 is a flow chart illustrating a method to prioritize business capability gaps, according to one embodiment.

FIG. 7 illustrates a table to describe projects to help close business capability gaps, according to one embodiment.

FIG. 8 illustrates a table to determine weighted scores for projects to help close business capability gaps, according to one embodiment.

FIG. 9 illustrates a table including prioritized projects to help close business capability gaps, according to one embodiment.

### DETAILED DESCRIPTION

Organizations may have more potential (or unfinished) projects than staff to complete them. As such, it is important that capability gaps are accurately prioritized to eliminate or avoid activities defining projects that close lower priority capability gaps and to optimize resource investments of time, money and people by focusing on highest priority capability gaps. Embodiments disclosed herein prioritize these capability gaps based upon the support closing the capability gap gives to accomplishing business initiatives. For example, embodiments disclosed herein may prioritize projects that close capability gaps that because closing such capability gaps strongly supports accomplishing business initiatives that are also identified as being high priority.

Embodiments disclosed herein provide techniques to prioritize business capability gaps to identify projects for organizations based on each project's level support for organizational goals and a prioritized set of business initiatives. Stated differently, embodiments disclosed herein prioritize business imperatives, and then prioritize and justify projects (such as information technology projects) based on each project's support of the business imperatives. Users may provide data revealing different capability gaps in an organization. The users may further provide data defining the effectiveness, criticality, and competitive differentiation for each of a plurality of business objectives (or initiatives, projects, imperatives, and the like) of the organization. The users may also provide data indicating how each business capability supports the fulfillment of each business objective. Based on the user-provided effectiveness, criticality, and competitive differentiation data, embodiments disclosed herein compute a weighted effectiveness, criticality, and competitive differentiation (ECD) score for each business objective. Based on the received data and the weighted ECD score, embodiments disclosed herein may then compute priority scores for each capability gap. The priority scores for each capability gap may then be outputted for display, allowing users to make informed decisions on which projects the organization should undertake.

Capability gaps may generally be defined as the difference between current operational capabilities and those necessary capabilities needed to perform objectives that remain unsatisfied. Stated differently, a capability gap may be considered as the difference between the ability of existing systems, organizations, or processes to meet operational requirements and expectations. For example, organizations may need to provide their staff with computers in order to allow the staff to complete their job-related duties. If there is more staff than computers available, a capability gap exists in this regard. If providing the computers to staff would greatly support other business initiatives, embodiments disclosed herein may place a high priority on providing computers to the staff. Generally, providing the computers to the staff would receive a higher priority relative to other capability gaps that are determined to provide less support to business initiatives.

Embodiments disclosed herein may use information technology (IT) capability gaps as a reference example. However, the disclosure is equally applicable to other capability gaps, and the use of IT capability gaps should not be considered limiting of the disclosure.

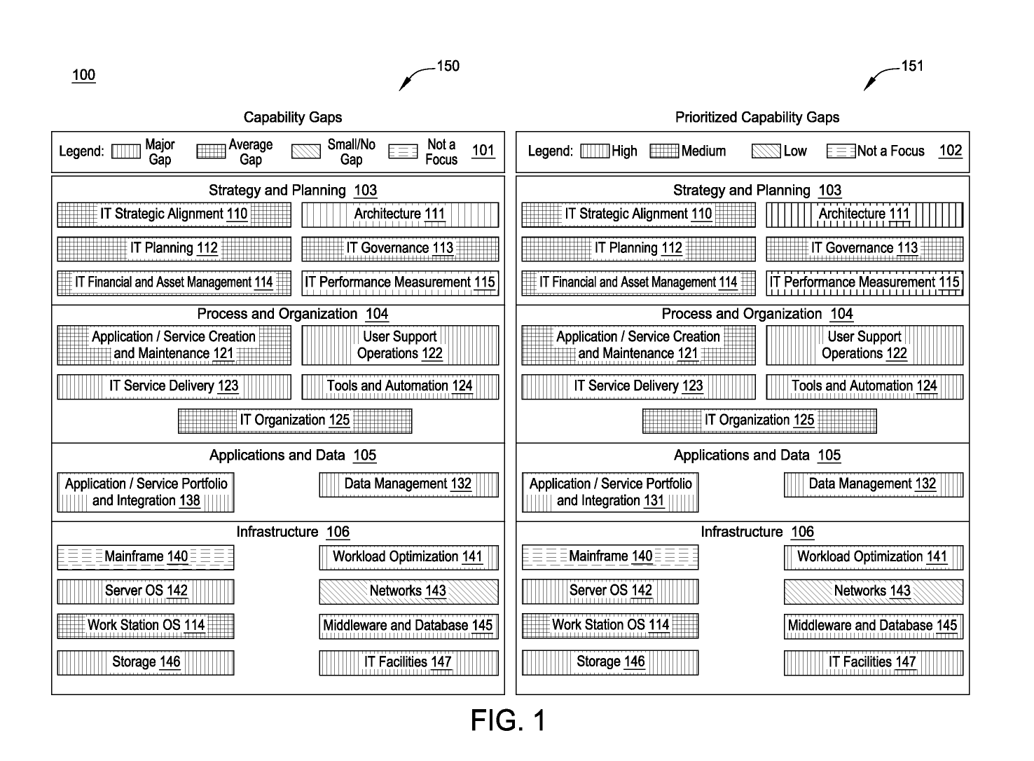

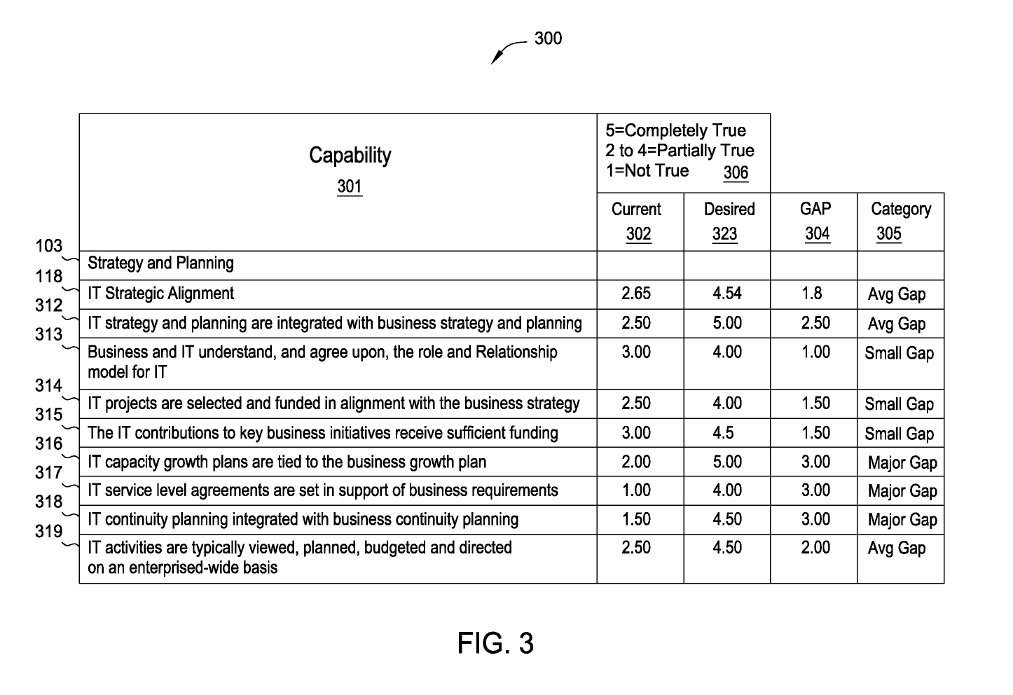

FIG. 1 illustrates a graphical user interface 100 depicting a table 150 for identified business capability gaps and a table 151 for prioritized business capability gaps, according to one embodiment. The table 150 may reflect business capability gaps identified from user input related to different business capabilities. The user input may specify, for example, current levels of compliance with the business capabilities and desired levels of compliance with the business capabilities. Based on the difference between the current and desired levels of compliance (or fulfillment), capability gaps may be identified. FIG. 3, discussed below, provides an example data set including such current and desired levels of compliance.

As shown in FIG. 1, a legend 101 in the table 150 depicts four categories for capability gaps, namely a major gap, an average gap, a small (or no) gap, and not a focus. Of course, any number and types of capability gaps may be defined as appropriate in a particular case. The business capabilities may be divided into categories. As shown, categories 103-106 have been defined for strategy and planning, process and organization, applications and data, and infrastructure, respectively. Furthermore, each category 103-106 includes capabilities 110-115, 121-124, 131-132, and 140-147, respectively. Generally, the table 150 allows users to visualize the identified capability gaps in the provided data, as well as the magnitude of each gap according to the legend 101. For example, IT strategic alignment 110 is determined to have an average gap, while a major gap is identified in IT performance measurement 115. Similarly, there is a small or no gap in networks 143, while mainframes 140 are not a focus.

Table 151 depicts the result of prioritizing the capability gaps displayed in table 150 according to the prioritization techniques disclosed herein. To prioritize the capability gaps, embodiments disclosed herein may compute a weighted effectiveness, criticality, and differentiation (ECD) score for each of a plurality of business objectives. In one embodiment, the weighted ECD score for each business objective is computed by the following equation:

$$\frac{( 11 - Effectiveness ) * ( Crititicality ) * 0.5}{10} + ( Differentiation ) * 0.5$$

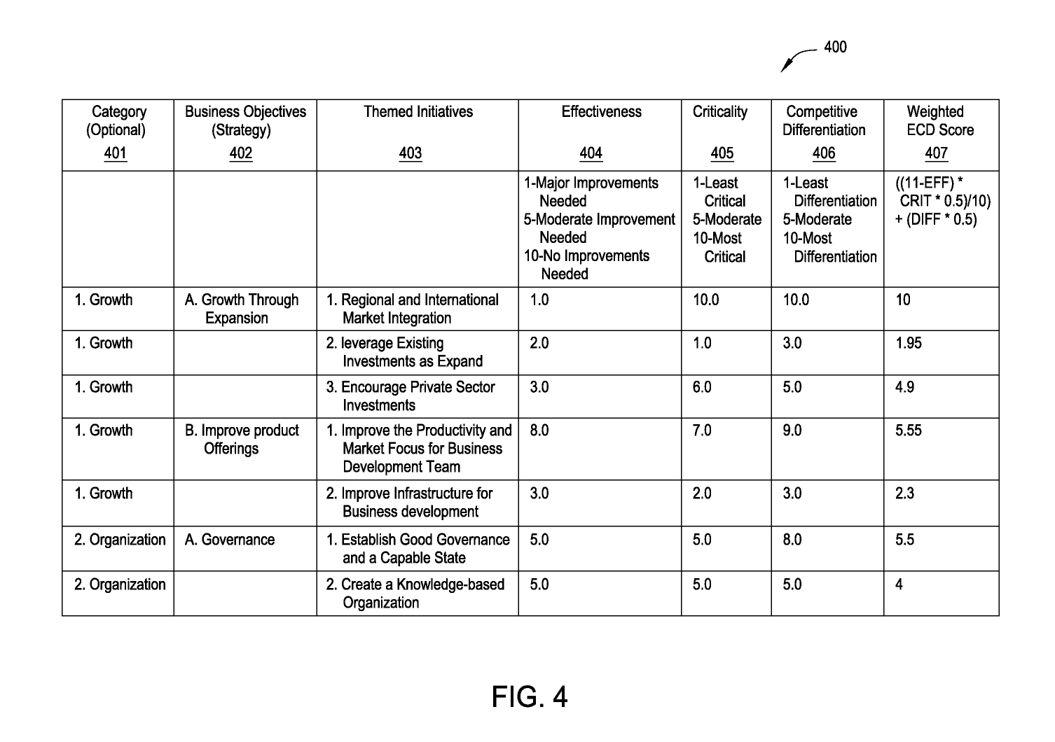

The values for effectiveness, criticality, and differentiation may be provided by a user, and may fall within a predefined range of values. These values correspond to the effectiveness, criticality, and competitive differentiation (vis a vis competitors) of each business objective (or imperative). Examples of such effectiveness, criticality, and differentiation values are shown with reference to FIG. 4.

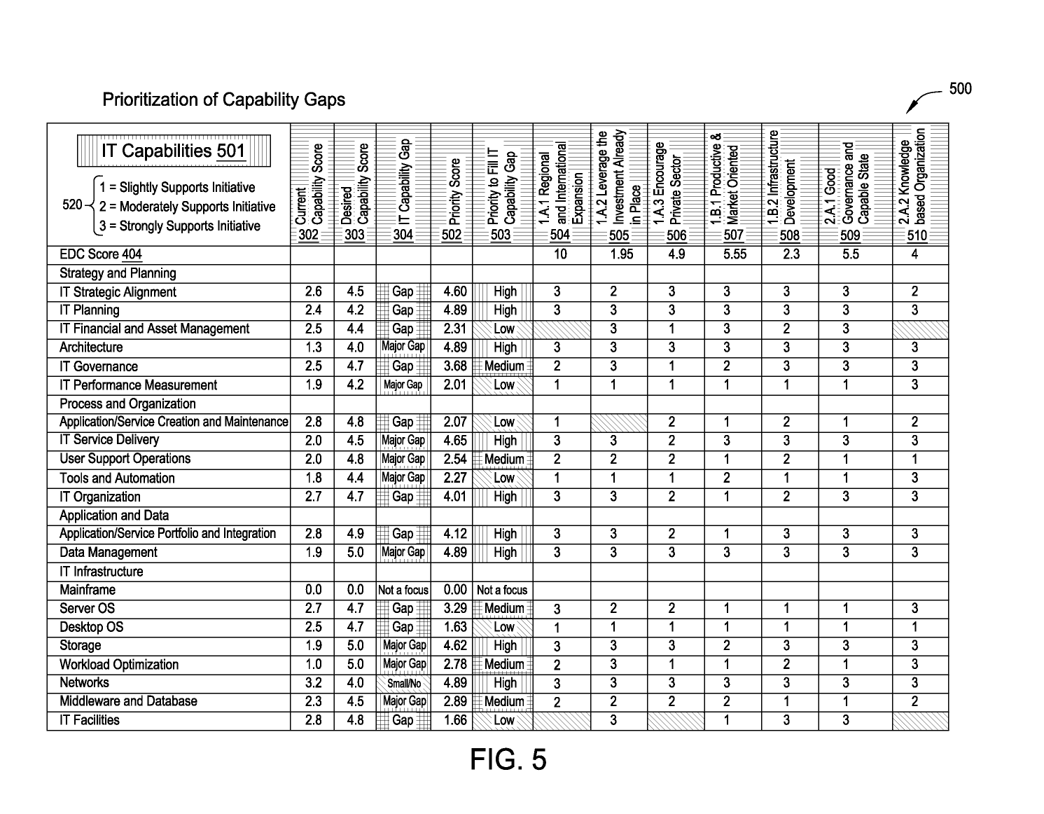

In addition, users may supply values for the level of support that each capability gap, if addressed (or closed or fulfilled), would provide towards achieving the different business initiatives. Examples of such support values are depicted in FIG. 5. Embodiments disclosed herein may then compute a priority for each capability gap based on the following equation:

$${P}_{m} = \frac{{\sum }_{1}^{n} {ECD}_{n} * {S}_{n}}{3 n}$$

Where P is the priority for each capability gap m, n is the number of business initiatives, ECD is the weighted ECD score for each business initiative, and S is the support that the capability gap would provide towards achieving the business initiative. Generally, the priority values generated by the equation may then be categorized in any feasible manner. For example, users may define different priority levels which correspond to ranges of priority values generated by the equation. The table 151 includes the legend 102, which reflects a set of different classes of prioritized capability gaps, namely high, medium, or low priority, or not a focus. The individual capabilities 110-115, 121-124, 131-132, and 140-147 in table 151 are shaded to reflect the P (priority) value generated for each respective capability. For example, IT strategic alignment 110 is a high priority gap, IT performance measurement 115 is a low priority gap, networks 143 is a high priority gap, and mainframes 140 are not a focus.

As shown, the size of a gap as reflected in table 150, does not always translate to a corresponding priority in table 151. For example, IT planning 141 is identified as an average sized gap in table 150, but a high priority gap in table 151. Therefore, users viewing these tables may realize that addressing the average gap in IT planning 141 is a high priority, as it would go far towards supporting different business objectives, as well as improving effectiveness, criticality, and differentiation. Similarly, networks 143 is a small capability gap, as reflected in table 150, but the computed P score for networks 143 indicates that networks are a high priority capability gap, as reflected in table 151. Conversely, the workstation OS 144 gap (which may relate to updating workstation operating systems), while identified as an average sized gap in table 150, is marked as a low priority gap in table 151. By displaying the workstation OS 144 as a low priority gap, users may be less tempted to address the workstation OS 144 gap, in spite of the average sized gaps between current and desired levels of workstation OS upgrades.

By prioritizing the gaps, and producing an output such as the table 151, embodiments disclosed herein allow organizations to make more informed business decisions pertaining to investing financial and human resources on different projects. Therefore, for example, the organization may choose to invest in IT planning over workstation operating systems, as the priority for the former is greater, in spite of the fact that both capabilities have average gaps.

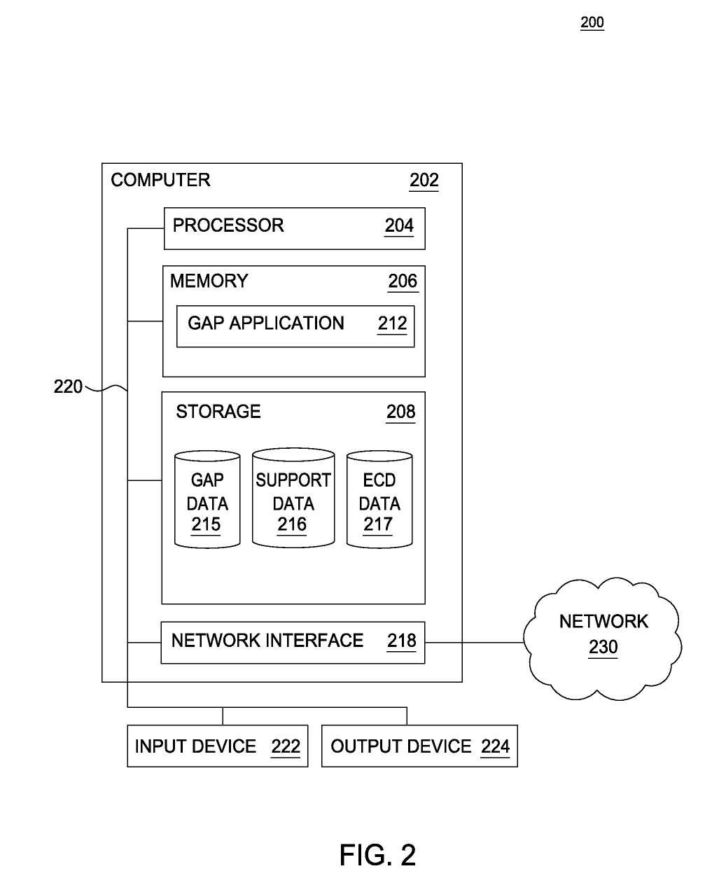

FIG. 2 illustrates a system 200 to prioritize business capability gaps, according to one embodiment. The networked system 200 includes a computer 202. The computer 202 may also be connected to other computers via a network 230. In general, the network 230 may be a telecommunications network and/or a wide area network (WAN). In a particular embodiment, the network 230 is the Internet.

The computer 202 generally includes a processor 204 connected via a bus 220 to a memory 206, a network interface device 218, a storage 208, an input device 222, and an output device 224. The computer 202 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 204 is included to be representative of a single CPU, multiple CPUs, a single CPU having multiple processing cores, and the like. The network interface device 218 may be any type of network communications device allowing the computer 202 to communicate with other computers via the network 230.

The storage 208 may be a persistent storage device. Although the storage 208 is shown as a single unit, the storage 208 may be a combination of fixed and/or removable storage devices, such as fixed disc drives, solid state drives, SAN storage, NAS storage, removable memory cards or optical storage. The memory 206 and the storage 208 may be part of one virtual address space spanning multiple primary and secondary storage devices.

The input device 222 may be any device for providing input to the computer 202. For example, a keyboard and/or a mouse may be used. The output device 224 may be any device for providing output to a user of the computer 202. For example, the output device 224 may be any conventional display screen or set of speakers. Although shown separately from the input device 222, the output device 224 and input device 222 may be combined. For example, a display screen with an integrated touch-screen may be used.

As shown, the memory 206 includes the gap application 206, which is an application generally configured to prioritize capability gaps. The gap application 206 may prioritize the gaps of different business capabilities based on the amount of support addressing the gap would provide towards meeting business objectives and a weighted ECD score for business initiatives. In at least one embodiment, the gap application 206 computes weighted ECD scores using the following equation, which was previously described in greater detail above:

$$\frac{( 11 - Effectiveness ) * ( Crititicality ) * 0.5}{10} + ( Differentiation ) * 0.5$$

In at least one embodiment, the gap application 206 may compute the priority for each business capability gap according to the following equation, which was previously described in greater detail above:

$${P}_{m} = \frac{{\sum }_{1}^{n} {ECD}_{n} * {S}_{n}}{3 n}$$

As shown, the storage 208 includes the gap data 215, the support data 216, and the ECD data 217. The gap data 215 may include data sufficient to identify capability gaps. For example, the gap data 215 may include values for current and desired levels of fulfillment of different capabilities. Based on these values, which may be provided by one or more users, the gap application 206 may identify gaps in the capabilities. Specifically, the gap application 206 may compute the difference between the values for each capability in order to identify gaps. If multiple users provide values for a given capability, the gap application 206 may average the scores, or take any feasible action in order to produce a single difference for each capability. The support data 216 stores values reflecting, for each business capability, a level of support expending resources or manpower to close the gap would have on each of a number of business goals, initiatives, objectives, and the like. Users may provide the values stored in the support data 216. The ECD data 217 includes user-specified values for effectiveness, criticality, and differentiation for each of a plurality of business objectives. Based on these values, the gap application 206 may compute a weighted ECD score for each objective. The gap application 206 may store the weighted ECD score in the ECD data 217.

FIG. 3 illustrates a table 300 storing current and desired levels of compliance with business capabilities to identify capability gaps, according to one embodiment. Generally, the table 300 shows, for each of a plurality of business capabilities 301, a current value 302, desired value 303, a gap 304, and a gap category 305. The capabilities 301 may be any type or category of business capabilities. The capabilities 301 may include higher level classes of capabilities, and specific statements related to each class of capability. For example, as shown, in the strategy and planning category 103 (of FIG. 1), there is an IT strategic alignment category 110. As shown, a plurality of statements 312-319 have been listed for the strategic alignment category 110. For each statement 312-319, a user may supply values for the levels of compliance within the organization. More specifically, the user may supply the current value 302, and a desired value 303. The current value 302 indicates the current level of compliance with the statements 312-319, while the desired level 303 indicates a level of compliance with the statements 312-319 that the user believes the organization should have. In some embodiments, the values 302 and 303 may be from a single user. Alternatively, multiple users may provide input, and their values may be averaged to generate values 302 and 303.

As shown, the users provide the current and desired values 302 and 303 on a scale ranging from 1-5, with 1 being not true, 2-4 being partially true, and 5 being completely true. For example, relative to statement 312, the user believes that the organization's IT strategy and planning are partially integrated with business strategy and planning, as reflected by the current score 302 of 2.5. However, as shown by the desired score of 5, the user believes that the organization's IT strategy and planning should be completely integrated with business strategy and planning. Based on the user-specified values 302, 303, a gap 304 may be identified. In one embodiment, as shown, the gap 304 is computed by subtracting the current 302 value from the desired 303 value. Therefore, as shown, there is a gap 304 of 2.5 for statement 312. The category 305 of gap specifies which type of gap the computed gap 304 difference falls into, such as the major, average, small, or not a focus categories previously discussed with reference to FIG. 1. For example, a small gap may be <1.5, an average gap may be 1.5 through 3.49, and a major gap may be 3.5 through 5. Generally, users (or system administrators) may define any number of scales and categories of gaps. Therefore, as shown, there is an average gap in category 305 for statement 312. As shown, a gap 304 and category 305 may be computed for overall categories, such as the IT strategic alignment 110. The table 300 may include a plurality of categories and statements that may not be shown in FIG. 3 that contribute to the IT strategic alignment 110 values 302-305. In at least one embodiment, the gap data 315 includes values corresponding to at least the current value 302 and desired value 303, for each capability and/or statement related to the capability.

FIG. 4 illustrates a table 400 including computed weighted effectiveness, criticality, and competitive differentiation scores 407 for business strategies, according to one embodiment. Generally, users within an organization may supply values for effectiveness 404, criticality 405, and competitive differentiation 406 for each of a plurality of business objectives 406 and associated initiatives 403. The values for effectiveness 404, criticality 405, and competitive differentiation 406 may be provided by a single user, or reflect aggregated values received from many users. Furthermore, the values 404-406 may be based on a respective scale, such as 1-10, as depicted. Based on the user provided scores, the gap application 206 may compute the weighted ECD score 407 for each initiative. For example, as shown, users have defined scores of 1, 10, and 10 for regional and international market integration, reflecting that the users believe major improvements are needed as far as effectiveness, that the initiative is most critical, and most differentiating. The gap application 206 may then compute the weighted ECD score 407 of 10, by supplying the user-defined values 404-406 to the following equation (previously discussed above):

$$\frac{( 11 - Effectiveness ) * ( Crititicality ) * 0.5}{10} + ( Differentiation ) * 0.5$$

Generally, any number of initiatives, imperatives, or objectives may be defined in the table 400. Furthermore, at least the values 404-406 and weighted ECD scores 407 may be stored in the ECD data 217.

FIG. 5 is a table 500 including computed priority scores 502 for identified business capability gaps, according to one embodiment. As shown, the table 500 includes the list of IT capabilities 501. The table 500 also includes the current and desired capability scores 302, 303, and the capability gap 304 from FIG. 3, as well as the weighted ECD score 407 from FIG. 4.

Generally, a user (or users) may specify whether addressing the capability gaps 304 for each IT capability 501 would support each initiative 504-510. It should be noted that the users may provide values for any number initiatives, imperatives, or objectives, as the initiatives 504-510 are shown for clarity and the sake of explanation. The support values may correspond to any number of predefined support scales. As shown, the scale 520 indicates that a score of 1 slightly supports the initiative, a score of 2 moderately supports the initiative, and a score of 3 strongly supports the initiative. If more than one user supplies support values, the values reflected in table 500 may be average values across all users. In at least one embodiment, the support values for each IT capability 501 vis a vis each initiative 504-510 may be stored in the support values 216.

As shown, the table 500 includes the priority score 502 for each IT capability 501. The gap application 206 may compute the priority score 502 in order to quantify the priority of addressing the gap 304 for the IT capability 501. In at least one embodiment, the gap application 206 may compute the priority score 502 with the following equation, previously discussed above:

$${P}_{m} = \frac{{\sum }_{1}^{n} {ECD}_{n} * {S}_{n}}{3 n}$$

Therefore, as shown, the gap application 206 may compute priority scores 502 of 4.6 for IT strategic alignment, 4.89 for IT planning, 2.31 for IT financial and asset management, and so on. The greater the priority score 502, the higher the priority of addressing the capability gap for the IT capability 501. Similarly, lower priority scores 502 indicate a lower priority in addressing the capability gap for the IT capability 501. As previously indicated, the priority scores 502 are based on the weighted ECD score 407 of the initiatives/objectives and the support that addressing the capability gap would provide towards business objectives. Once the gap application 206 computes the priority score 502, the gap application 206 may also compare the values to a predefined range of scores for priority classes, such as low, medium, and high priority. The range of scores may be defined by a user, a system administrator, or the gap application 206. For example, a user may define a high priority score as greater than 4, a medium priority score as between 1 and 4, and a low priority score as lower than 1. Generally, any range may be defined suitable to rank different categories of priority relative to each other. Therefore, the priority class 503 reflects the priority of addressing each IT capability 501. As shown, based on the priority score 502 of 4.65, IT service delivery is considered to be a high priority capability gap. As shown, based on the priority score 502 of 1.66, IT facilities are considered to be a low priority capability gap.

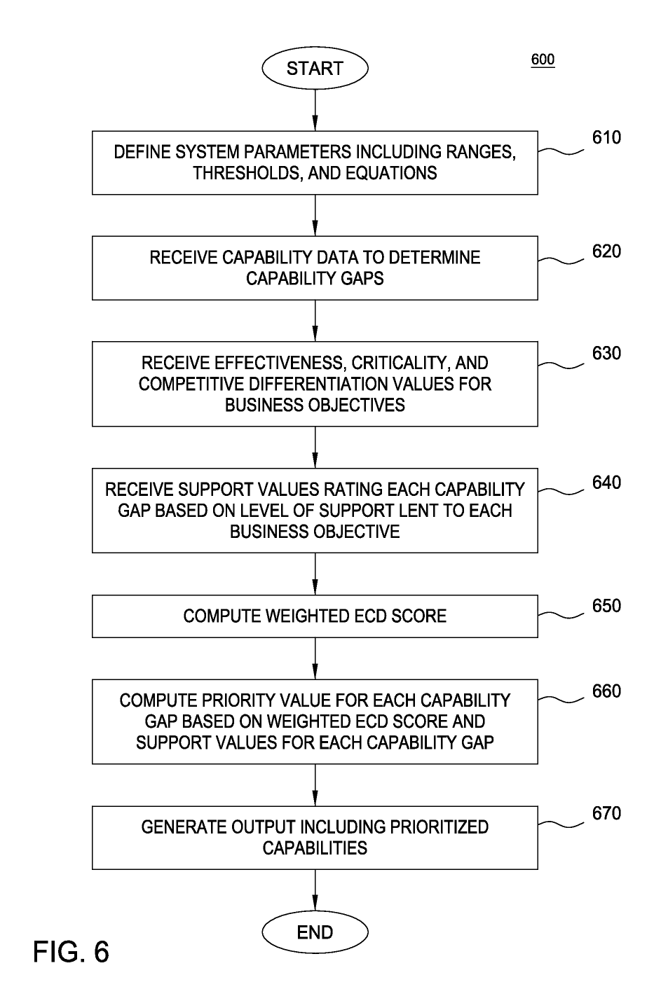

FIG. 6 is a flow chart illustrating a method 600 to prioritize business capability gaps, according to one embodiment. Generally, the steps of the method 600 prioritize gaps in business capabilities vis a vis other gaps in business capabilities. Doing so allows users to better determine which gaps should be addressed first. The prioritization may be based on the importance (or priority) of business objectives (reflected by their respective weighted ECD scores) as well as the support each capability gap would provide toward each business objective (or initiative). In one embodiment, the gap application 206 performs the steps of the method 600.

At step 610, the gap application 206, a user, or a system administrator may define different system parameters, such as ranges, thresholds, and equations. The parameters may include, without limitation, current and desired capability compliance ranges, gap size classes, gap priority classes, support ranges, and effectiveness, criticality, and competitive differentiation ranges. The equations may include, without limitation, equations to compute the weighted ECD scores and the priority scores. At step 620, the gap application 206 may receive current and desired compliance values 302 and 303 for each of a plurality of capabilities (and associated statements), in order to determine capability gaps. The gap application 206 may receive the values from a user, or from the gap data 215. In one embodiment, the gap application 206 may determine the capability gaps by computing the difference between the desired and current values for the respective capability. At step 630, the gap application 206 may receive the effectiveness, criticality, and competitive differentiation values 404-406 for each of a plurality of business objectives. The gap application 206 may retrieve the values 404-406 directly from the user, or from the ECD data 217. At step 640, the gap application 206 may receive support values rating the amount of support each business capability would provide to the business initiatives, objectives, or initiatives, if addressed. Examples of such support values include the values 504-510 of FIG. 5.

At step 650, the gap application 206 may compute the weighted ECD score 407 for each business initiative (or objective or imperative). The weighted ECD score may reflect an overall importance, or priority, of each business initiative. At step 660, the gap application 206 may compute a priority value 502 for each capability gap based on the weighted ECD score 407 and the amount of support each capability gap would provide to each respective business initiative. In generating the priority score 502, the gap application 206 may provide a measure of priority for each business capability. At step 670, the gap application 206 may generate an output including the computed priority scores and reflecting the overall priority of addressing each capability gap. Examples of such output include tables 151 and 500.

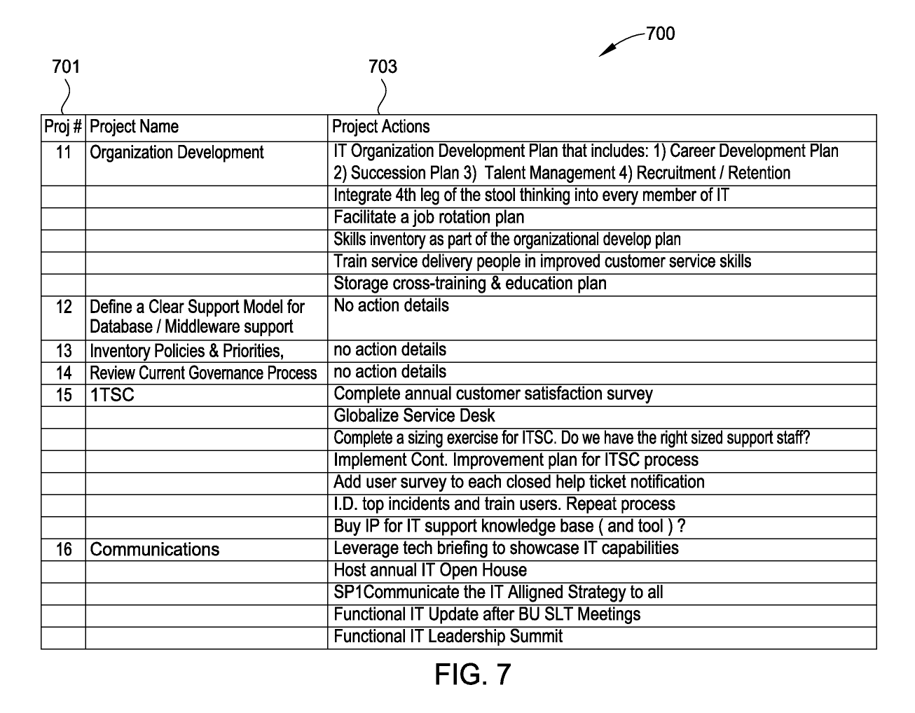

FIG. 7 illustrates a table 700 to describe projects to help close business capability gaps, according to one embodiment. Generally, users may fill out the table 700 to suggest projects to help close business capability gaps, either for all business capabilities, or a subset of the highest priority capability gaps. As shown, the table 700 includes a project number 701, a project name 702, and a project actions 703. Generally the project number 701 is a value to identify each project. The project number 701 may be automatically assigned for each new project added to the table 700. The project name 702 is a name for the project, which may be supplied by a user. The project actions 701 include a description of associated actions provided by the user. For example, a project 11 is named organization development which includes a plan for career development, succession, talent management, and recruiting/retention. Embodiments disclosed herein may prioritize the projects based on their ability to close capability gaps, as described above.

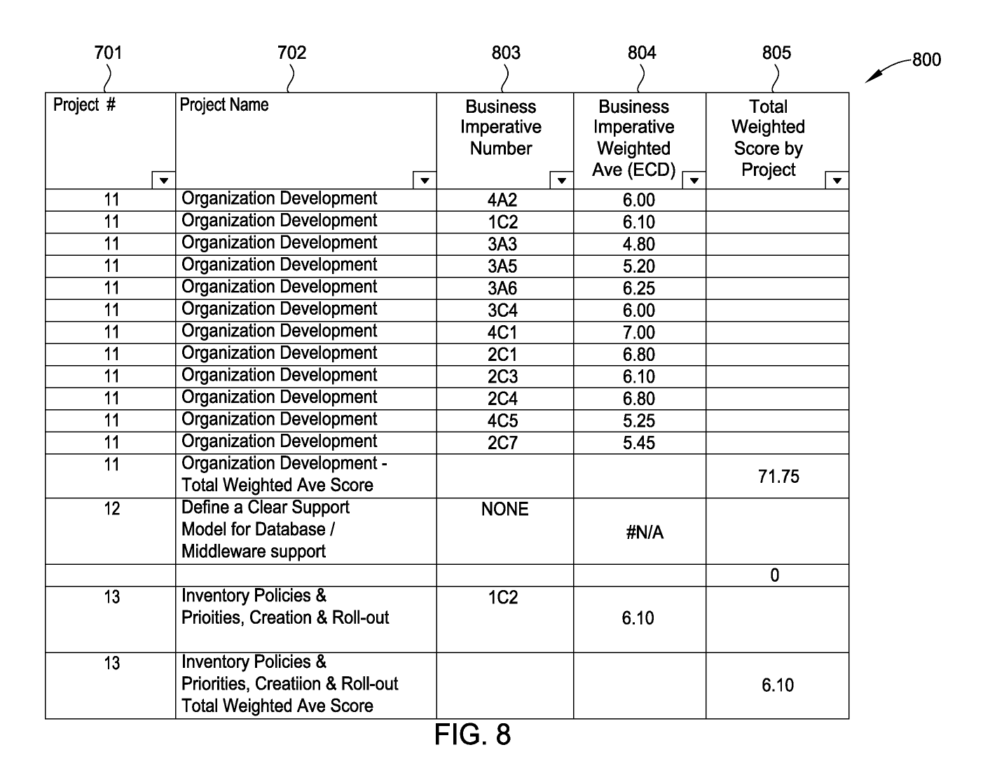

FIG. 8 illustrates a table 800 to determine weighted scores for projects to help close business capability gaps, according to one embodiment. Generally, in the table 800, each project is connected to the business imperatives the project supports, and an algorithm is used to determine each project's weighted score. As shown, the table 800 includes the project number 701, project name 702, business imperative number 803, business imperative weighted average 804, and a total weighted score by project 805. The business imperative number 803 may be an identifier assigned to a given business imperative. The business imperative weighted average 804 is the effectiveness, criticality, and differentiation (ECD) score, computed according to the equation described above. The total weighted score by project 805 includes a sum of all ECD scores for business imperatives supported by a given project. Therefore, as shown, the total weighted average score 805 for organization development is 71.75, while it is 6.10 for inventory policies and priorities.

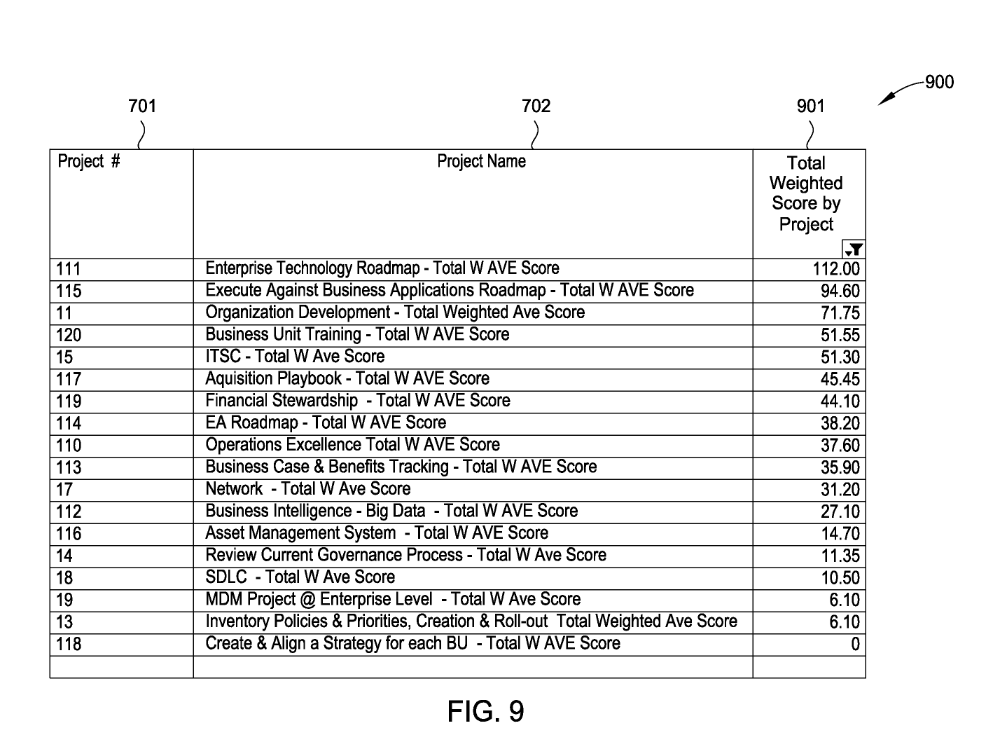

FIG. 9 illustrates a table 900 including prioritized projects to help close business capability gaps, according to one embodiment. Generally, the table 900 reflects a listing of business projects that are prioritized by weighted score. As shown, the table 900 includes the project number 701, the project name 702, and a total weighted project score 901. The total weighted project score 901 reflects the level of support each business project provides for business imperatives across all imperatives. Using the weighted project scores 901, all projects can be ranked to indicate an overall prioritization across all business imperatives.

Advantageously, embodiments disclosed herein provide techniques to prioritize capability gaps based on the importance (or priority) of different business initiatives and the extent to which addressing the capability gaps would support those initiatives. In doing so, embodiments disclosed herein allow users to visualize the most important initiatives, regardless of the size or magnitude of the capability gap, enabling users to make more informed decisions on which capability gaps should be addressed. By providing algorithms directed to business optimization prioritization, capability gap prioritization, and project prioritization, the algorithms can be used in any different combinations (such as any two of the three algorithms). The result is a weighted score for all proposed projects.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the gap application 206 could execute on a computing system in the cloud and prioritize different business capability gaps for different organizations. In such a case, the gap application 206 could compute priority scores for the capability gaps, and store the priority scores at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method to prioritize capability gaps, comprising:
determining, for each of a plurality of business objectives, a weighted effectiveness, criticality, and differentiation (ECD) score; and
determining, by operation of one or more processors, a priority value for each of a plurality of capability gaps based on: (i) the weighted ECD score of each business objective, and (ii) a degree of support the respective capability gap provides towards fulfilling each business objective, wherein each priority value reflects a degree of importance of a capability subject to the respective capability gap.

2. The method of claim 1, further comprising:
generating a graphical user interface (GUI) conveying the respective priority value for each capability gap; and
outputting the GUI for display.

3. The method of claim 1, further comprising:
receiving capability data for each of a plurality of capabilities, wherein the capability data comprises current levels and desired levels of fulfillment of each of the capabilities; and
identifying the plurality of capability gaps based on differences between the current levels and desired levels with fulfillment of each of the capabilities.

4. The method of claim 1, further comprising:
receiving, for each business objective, an effectiveness value, a criticality value, and a differentiation value determined according to a first predefined equation comprising:
Weighted ECD score=(11−Eff)*(Crit)*0.5/10+(Diff)*0.5.

5. The method of claim 4, wherein the priority value is determined according to a second predefined equation comprising:
$${P}_{m} = \frac{{\sum }_{1}^{n} {ECD}_{n} * {S}_{n}}{3 n} .$$

6. The method of claim 1, further comprising:
receiving, for each capability, support values indicative of the degree of support the respective capability gap provides towards fulfilling each business objective.

7. The method of claim 1, wherein the capabilities comprise information technology (IT) capabilities.
